(19) United States
(12) Patent Application Publication
(10) Pub. No.: US 2013/0282948 A1
(43) Pub. Date: Oct. 24, 2013

(54) System and method for system wide self-managing storage operations

(71) Applicants: Duarte Miguel Brazao, Hollis, NH (US); John O'Brien, Short Hills, NJ (US)

(72) Inventors: Duarte Miguel Brazao, Hollis, NH (US); John O'Brien, Short Hills, NJ (US)

(21) Appl. No.: 13/694,744

(22) Filed: Jun. 28, 2013

Related U.S. Application Data
(60) Provisional application No. 61/631,272, filed on Dec. 31, 2011.

(51) Int. Cl. G06F 13/28

(52) U.S. Cl. CPC G06F 13/28
USPC 710/308

(57) ABSTRACT

The present invention presents a system and method to provide a storage system wide approach to better manage IO requests and better manage the prefetch transfers of data to and from the drives.

### PRIORITY INFORMATION

This application claims priority of U.S. provisional application Ser. No. 61/631,272, filed Dec. 31, 2010, entitled, “System and Method for System Wide Self-Managing Storage Operations”

### FIELD OF THE INVENTION

The present invention relates to a computer system, storage system, and more particularly, to disk drive operations.

### BACKGROUND OF THE INVENTION

FIG. 1 shows a prior art storage system 111 for disk drive operation with a plurality of storage elements 101. As depicted in FIG. 1-A, an individual storage element 101 is comprised of a controller interface 102, processing capability 103, memory and a driver program 104.

The storage system of the prior art in FIG. 1, shows a plurality of storage elements 101, connected to a controller or adapter board 115, and connected via the bus 114 from the controller board to one or more processors 122, main memory and program(s) 113, and one or more host connection 110 which may include host interface boards and or network interface cards.

The controller interfaces 115 may be of several different popular type including but not limited to: SCSI, ATA, SATA, and Fibre Channel.

Most drives support some type of Command Tag Queuing, or Native Command Queuing. Even though the implementation details vary from drive type to drive type, the intention of passing the queue to the drive and let it minimize rotational latency remains the same objective across the different implementations.

In order for a Command Tag Queuing (CTQ) solution to work, all components in the chain must support this feature. For example, under SCSI, for a host which supports command tag queuing, the following six parts must all support the same compatible versions of Command Tag Queuing: (i) the host adapter, (ii) the Storage System SCSI adapter, (iii) the Storage System SCSI adapter device driver, (iv) the storage device SCSI controller, (v) the storage device driver, and (vi) the SCSI device itself. If there is a breakdown in this chain, or different views of the CTQ specification interpretation, then the CTQ solution will not be as effective—or possibly work at all.

FIG. 2 shows the same prior art storage system 111 shown in FIG. 1 with some added detail about prior art Command Tag Queuing. In addition, FIG. 2 shows the same storage element components of FIG. 1A explicitly incorporated into storage element D1, 201. These same components are in each of the Storage Elements 101, they are just shown explicitly in 201 for explanation purposes. The other elements which support command tag queuing are also shown in FIG. 2 namely: the host adapter 203, the Storage System SCSI adapter 205, the Storage System SCSI adapter device driver 202, the storage device SCSI controller 102, the storage device driver 104, and the SCSI device storage media itself 105.

Solid state drives have no rotational latency and they basically, as part of a storage system, they are witnesses to host based IO latency as opposed to being sources of IO rotational latency such as are rotational drives.

### SUMMARY OF THE INVENTION

It is the object of the present invention to provide more efficient data drive storage operations through a system wide self managed storage mechanism.

### BRIEF DESCRIPTION OF THE DRAWINGS

Features and advantages of the present invention will become apparent to those skilled in the art from the following description with reference to the drawings, in which:

FIG. 1 is a diagrammatic presentation of a prior art storage system.

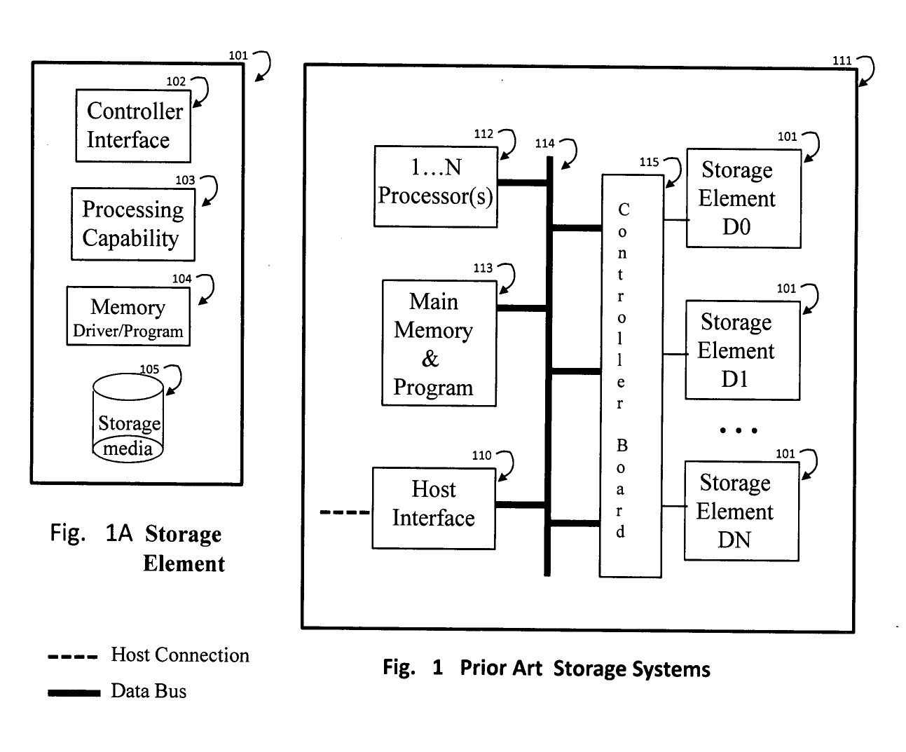

FIG. 2 is a diagrammatic presentation of a prior art storage system with Command Tag Queuing implemented.

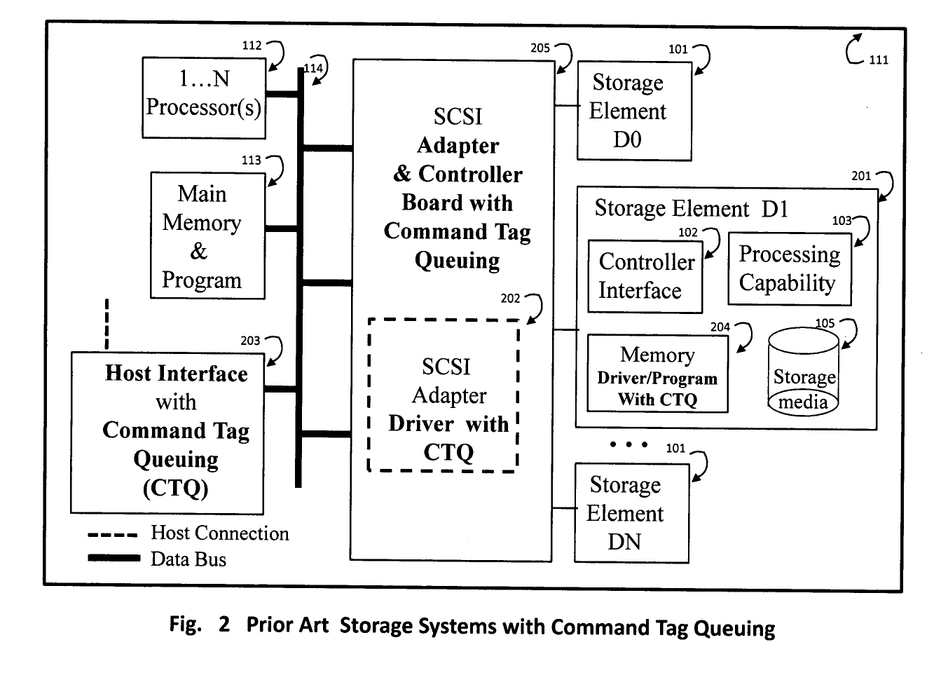

FIG. 3 is a diagrammatic presentation of an embodiment of the present invention implementing self managed storage.

### DETAILED DESCRIPTION OF INVENTION AND SOME PREFERRED EMBODIMENTS

To better appreciate the present invention, we first discuss some deficiencies with the prior art which we seek to correct.

As discussed above a successful SCSI CTQ operation relies upon: the host adapter 203, the Storage System SCSI adapter 205, the Storage System SCSI adapter device driver 202, the storage device SCSI controller 102, the storage device driver 104, and the SCSI device storage media itself 105. It is very possible that the six pieces of code which control the CTQ operation were each authored at a different company. In addition, the storage element, may be set to do prefetch or not. What results is a series of disjointed software all seeking to help throughput in some way, but doing so in a loosely coordinated manner. This is not unlike having a group of skilled musicians all eager to play a musical piece without having a conductor.

Consider the example of three different applications competing for storage resources. The applications are related, but different, and deal with some of the same data files. Application 1 makes a request for two large stored files. This request makes its way through the storage system and eventually results in the controller board pushing pages of data from the drive(s) into main memory. Application 2 now requests files of its own needs—some of which overlap what was just requested by application 1. To make room for the second request, the memory manager de-stages some of the application 1 data, and ends up re-requesting the same data on behalf of application 2.

Application 3 now requests some data from a database application and because drive prefetch is on, many records of the database not of interest are also returned to memory.

What is happening is that absent some overall perspective and control. Each part of the system is trying to second guess its source and its destination. The result is both extra work as well as the lost opportunities to mitigate or eliminate work.

Some work may be mitigated by sorting a system wide queue of IOs thereby reducing the effects of rotational latency over and above CTQ, and some work can be mitigated by benefiting from prefetch operations dynamically engaged at the correct time.
Some work may be eliminated by not writing to the same disk area twice in rapid succession and only committing the final WRITE, and other work can be eliminated by not destaging memory of contents which will be immediately requested, and still other work can be eliminated by obviating prefetch operations dynamically disengaged at the correct time.

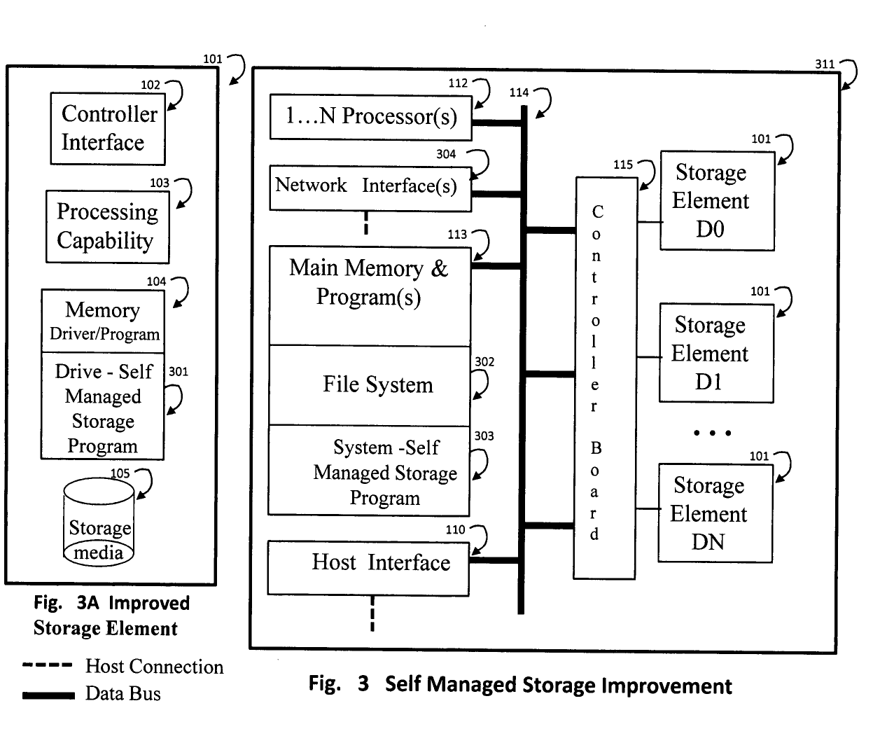

One of the preferred embodiments of the present invention involves the use of a storage system functioning as one or more file servers or alternatively functioning with a file server as one client of a plurality of clients. FIG. 3A depicts the addition of self managed storage software 301 in the storage element, and FIG. 3 depicts related but different self managed storage software 303 associated with main storage memory and the processor in the improved storage system 311. A File System 302 is explicitly shown in this embodiment, indicating that this particular embodiment is operating, either in whole or in part, as a file server. One or more Network Interface adapters 304 is also explicitly shown, as examples of host connections, to assist in connecting the file system via a NAS connection.

The self managed storage software 303 has two tables to help manage data. Each table organizes that data into pages of data, analogous to a demand page memory system. The first table, is used to manage pages of data mapping from main memory to the plurality of disk drives, or storage elements 101, which store data.

The second table manages outstanding IO requests from the associated file system organizing pages of data mapped from the file system IO requests to main memory.

These two tables are then reconciled so that an over all view can be made of all pending IO requests. This over all view is then sorted first by first dividing the individual IOs based upon target drives, and the by sorting each drive's IOs into monotonic track numbers for that drive.

Because this view effectively maps all pending IO for all outstanding requests, it can be used to manage overlapping requests and to obviate other requests by virtue of re-writes and data which already present in memory.

The individual drive IO sorts represent a more complete sorted list of IO than conventional CTQ as they integrate all know IOs at a point in time.

These drive IO lists are updated dynamically, in real time, and dispatched to the individual drives timed to keep each drive busy.

Another aspect of the present invention is an ability of the self managed storage software 303 to monitor File System usage patterns and determine when it would increase performance of the overall system by turning individual drive prefetch on and off. This also includes keeping track of the different drives prefetch states. This on off advantage is resolved down to the individual drives, and corresponding commands are asynchronously sent over the data bus to the effected drives where the drive self managed storage program 301 interprets the message and causes the prefetch state to change as requested.

These capabilities of completely managing the queue of each drive from a system perspective and being able to dynamically change the prefetch state on a drive by drive basis, provide substantial performance benefits.

Another of the preferred embodiments of the present invention involves the use of a storage system functioning as Storage Area Network SAN with a plurality of attached clients using either direct connect attachments such as Infiniband, SCSI, Fibre Channel, or Ethernet, GigE, or some mix, or equivalent method of attachment.

Using the same method of reconciling the two different page mapping tables discussed above and ordering IO requests for the different drives and prefetch management, the present invention helps resolve IOs to be more efficient, and hence to improve performance.

Although the present invention has been described in terms of particular embodiments, it is not intended that the invention be limited to these embodiments. Modifications within the spirit of the invention will be apparent to those skilled in the art. For example, in alternate embodiments of the present invention, the physical drive elements may be replaced with other storage devices such as holographic or other means. In addition, one skilled in the art may choose to distribute the drive self managed system program 301 with some portion of the code on the storage drive itself and the remaining portion on the controller board.

In summary, the present invention presents a system and method to provide a storage system wide approach to better manage IO requests and better manage the prefetch transfers of data to and from the drives.

1. A method for providing access from one or more host computer systems to a multi-node data storage system where access to a storage space could be made via any connected host with access permission connected to a Storage Node, said Storage Nodes connected by an Interconnected Bus, said storage space of the Storage Nodes being made up of one or more physical storage elements, or portions of one or more storage elements, comprising the steps of:
a) connecting at least one host or client to a to an IO or network connection on one Storage Nodes;
b) connecting at least one host or client to a to an IO or network connection on one or more additional Storage Nodes;
c) performing multicast IO transfers over an interconnected bus connected to the memory of each Storage Node in the storage system to write to a volume on that node.
d) responding to host IO requests and managing a Logical Storage Capacity for each Storage Node to aggregate and track the storage capacities of data drives are available within the Storage Node including which Nodes may access the drives.
